(19) United States
(12) Patent Application Publication
(10) Pub. No.: US 2024/0140000 A1
(43) Pub. Date: May 2, 2024

(54) CONCRETE MATERIAL DELIVERY SYSTEM AND METHOD

(71) Applicant: ROY BROWNELL, OLATHE, KS (US)

(72) Inventor: ROY BROWNELL, OLATHE, KS (US)

(21) Appl. No.: 17/977,199

(22) Filed: Oct. 31, 2022

(51) Int. Cl. B28C 7/00; B28C 5/08; B28C 7/04; B28C 7/06

(52) U.S. Cl. CPC B28C 7/0069; B28C 5/0818; B28C 5/0856; B28C 7/0076; B28C 7/0418; B28C 7/0486; B28C 7/067

(57) ABSTRACT

A system for delivery ingredients to a cement mixing barrel has a container. The container is divided into a plurality of compartments, each compartment used to store one ingredient for making cement. A dispensing opening is formed in a bottom area of each of the plurality of compartments. A delivery trough is positioned below each dispensing opening transferring the ingredient from each of the plurality of compartments to the cement mixing barrel.

### TECHNICAL FIELD

The present application generally relates to concrete, and more specifically, to a concrete material delivery system which measures and delivers the proper amount of each solid ingredient to a concrete mixing machine.

### BACKGROUND

Concrete is a composition or paste mixture of cement, fine aggregates such as sand, and coarse aggregates like gravel/rock. These solid materials are mixed with water in a concrete mixing machine and then used on construction projects where the concrete cures over time. The ingredients in making the concrete should be added in standardized ratios to ensure perfect workability, durability, and strength of the concrete.

For large construction projects, the concrete may be formed in a concrete batching plant. The concrete may then be loaded onto concrete mixing trucks which transports the concrete to a desired location for use. Unfortunately, most people do not require these large amounts of concrete.

Many construction jobs use smaller concrete mixing barrels for forming the concrete. These concrete mixing barrels may come in sizes from 1.5 cubic feet to 10 cubic feet or more. For these jobs, the cement, sand, and gravel/rock may be poured into the concrete mixing barrel. Loading the different ingredients can be very tiring and time consuming. Further, many times, the person making the concrete may forget how much of each ingredient is needed or may forget how much of a particular ingredient has already been added into the concrete mixing barrel.

Therefore, it would be desirable to provide a system and method that overcomes the above. The system and method would disperse and load the proper amount of each ingredient into a concrete mixing barrel.

### SUMMARY

In accordance with one embodiment, a system for delivery ingredients to a cement mixing barrel is disclosed. The system has a container. The container is divided into a plurality of compartments, each compartment used to store one ingredient for making cement. A dispensing opening is formed in a bottom area of each of the plurality of compartments. A delivery trough is positioned below each dispensing opening transferring the ingredient from each of the plurality of compartments to the cement mixing barrel.

In accordance with one embodiment, a system for delivery ingredients to a cement mixing barrel is disclosed. The system has a container. The container is divided into a plurality of compartments, each compartment used to store one ingredient for making cement. A dispensing opening is formed in a bottom area of each of the plurality of compartments. A delivery trough is positioned below each dispensing opening transferring the ingredient from each of the plurality of compartments to the cement mixing barrel. A metering device is coupled to each dispensing opening. The metering device controls disbursement of the ingredient in each of the plurality of compartments. The metering device has a dispensing unit coupled to each dispensing opening and a controller coupled to each dispensing unit.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1 is a perspective view of an exemplary embodiment of a concrete material delivery system in accordance with an aspect of the present invention; and

FIG. 2 is a cross-sectional view of an exemplary embodiment of a material storage and dispensing unit of the system of FIG. 1, in accordance with an aspect of the present invention.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary concrete material delivery system is disclosed. The concrete material delivery system measures and delivers the proper amount of each solid ingredient to a concrete mixing machine.

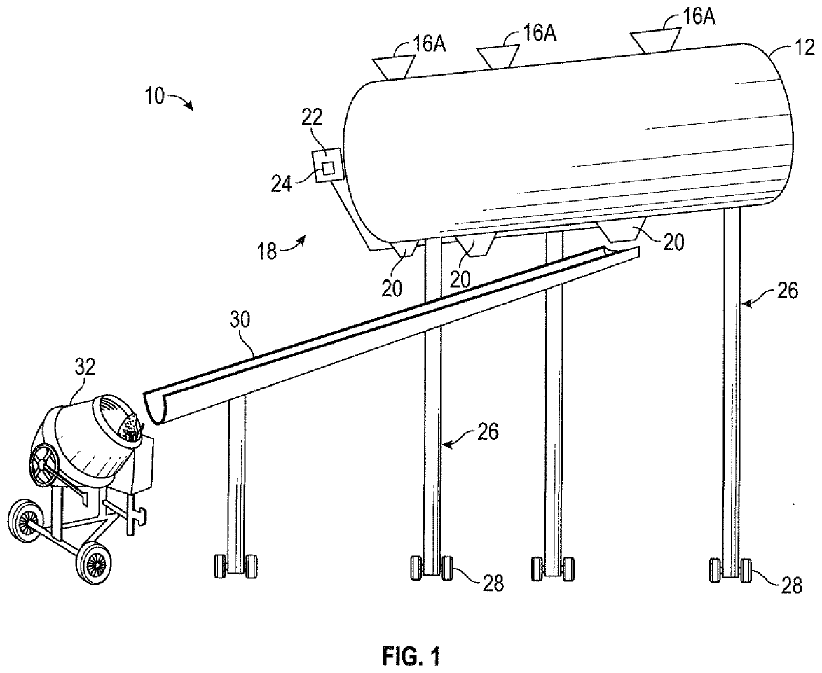

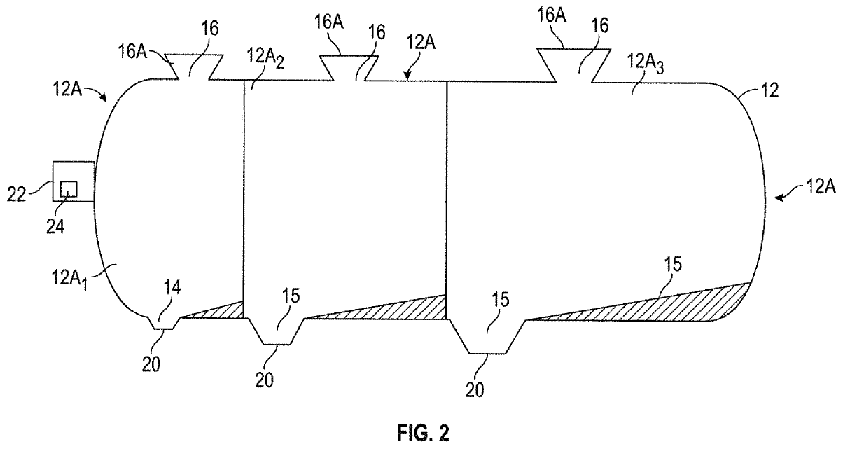

Referring to FIGS. 1-2, a concrete material delivery system 10 (herein system 10) may be seen. The system 10 may have a storage tank 12. The storage tank 12 may come in different shapes and sizes. While the present embodiment may show the storage tank 12 as being oblong in shape, this is given as an example and should not be seen in a limiting manner. The storage tank 12 may come is different shapes and sizes based on a desired usage and/or a size of the construction project.

The storage tank 12 may be hollow structure. The storage tank 12 may be divided into multiple compartments 12A. The number of compartments 12A may be based on the number of materials needed for forming concrete. In the present embodiment, the storage tank 12 may be divided into three different compartments 12A. Each of the compartments 12A may be separated from each other so that the contents of one compartment 12A cannot flow into another compartment 12A.

When forming concrete, three main ingredients may be used: cement, sand, and gravel/rocks. In accordance with one embodiment, a first compartment 12A₁ may be sized to hold the cement, a second compartment 12A₂ may be sized to hold the sand and a third compartment 12A₃ may be sized to hold the gravel/rocks. In general, the second compartment 12A₂ may be twice the size of the first compartment 12A₁ and the third compartment 12A₃ may be three times the size of the first compartment 12A₁.

A dispersing opening 14 may be formed in a bottom area of each compartment 12A. The dispersing opening 14 may be used to discharge the ingredients from each respective compartment 12A from the storage tank 12.

The floor 15 of each compartment 12A may be formed at an angle and/or slanted. The floor 15 may be formed at an angle/slant such that the dispersing opening 14 may be formed at a bottom of the slanted floor 15. This may allow the ingredients stored in the compartment 12A to flow down the slanted floor 15 and out of the dispersing opening 14 of each of the compartments 12A.

A loading opening 16 may be formed in a top area of each compartment 12A. The loading opening 16 may be used to load/resupply each compartment 12A with the proper ingredient. A lid 16A may be formed on top of each loading opening 16. The lid 16A may prevent non-desirable debris from entering into each compartment 12A.

The system 10 may have a metering device 18. The metering device 18 may be used to monitor and control an amount of an ingredient being released from each compartment 12A. The metering device 18 may be formed of a dispensing unit 20 and a controller 22. An individual dispensing unit 20 may be coupled to each dispensing opening 14. The dispensing unit 20 may open and close to dispense a desired amount of the ingredient stored in the corresponding compartment 12A. Each of the dispensing units 20 may be coupled to the controller 22. The controller 22 may be used to control the opening and closing of each dispensing unit 20. The controller 22 may have a user interface 24 to allow a user to program/select the desired amount of each ingredient to be dispensed from each compartment 12A. In accordance with one embodiment, the controller 22 may be preprogrammed to dispense the ingredients in the following ratios: 1 part cement to 2 parts sand to 3 parts gravel/rocks.

The container 12 may be placed on a frame 26. The frame 26 may be used to raise the container 12 off the ground to allow the ingredients to be dispensed out of each dispersing opening 14. In accordance with one embodiment, the frame 26 may secure the container 12 at an angle/slant. The frame 26 may be slanted so that for each compartment 12A, the respective dispensing unit 20 is at a lower positioned than a remaining portion of the respective compartment 12A. The frame 26 may have a plurality of wheels 28 coupled thereto. The wheels 28 may allow the container 12 with the frame 26 to be transportable.

The system 10 may have a delivery trough 30. The delivery trough 30 may be positioned below the dispensing units 20 and is used to transfer the ingredients being dispensed to a concrete mixing barrel 32. The delivery trough 30 may have a frame 32. The frame 32 may be used to raise the delivery trough 30 off the ground to allow the ingredients to flow down the delivery trough 30 and into the concrete mixing barrel 32. In accordance with one embodiment, the frame 32 may secure the delivery trough 30 at an angle/slanted. The frame 32 may be slanted to allow gravity to transport the ingredients from each compartment 12A to flow down the delivery trough 30 and into the concrete mixing barrel 32. The frame 32 may have a plurality of wheels 34 coupled thereto. The wheels 34 may allow the delivery trough 30 with the frame 32 to be transportable to adjust a position and location of the delivery trough 30.

The foregoing description is illustrative of particular embodiments of the invention, but is not meant to be a limitation upon the practice thereof. The following claims, including all equivalents thereof, are intended to define the scope of the invention.

What is claimed is:

1. A system for delivery ingredients to a cement mixing barrel comprising:
a container, wherein the container is divided into a plurality of compartments, each compartment used to store one ingredient for making cement;
a dispensing opening formed in a bottom area of each of the plurality of compartments; and
a delivery trough positioned below each dispensing opening transferring the ingredient from each of the plurality of compartments to the cement mixing barrel.

2. The system of claim 1, comprising a metering device coupled to each of the dispensing openings, the metering device controlling disbursement of the ingredient in each of the plurality of compartments.

3. The system of claim 1, comprising a loading opening formed in a top area of each of the plurality of compartments.

4. The system of claim 1, comprising a container frame coupled to the container, wherein the container frame raises the container allowing the ingredient in each compartment to be dispensed out of the dispensing opening of each compartment.

5. The system of claim 4, wherein the container frame secures the container at an angle.

6. The system of claim 4, comprising wheels coupled to the container frame.

7. The system of claim 1, comprising a delivery trough frame coupled to the delivery trough, wherein the delivery trough frame positions the delivery trough below each dispensing opening and at a slant allowing each ingredient dispensed from each compartment to flow down the delivery trough.

8. The system of claim 2, wherein the metering device comprises:
a dispensing unit coupled to each dispensing opening; and
a controller coupled to each dispensing unit.

9. The system of claim 2, wherein the metering device comprises a user interface coupled to the controller.

10. The system of claim 1, wherein a floor of each compartment is slanted.

11. A system for delivery ingredients to a cement mixing barrel comprising:
a container, wherein the container is divided into a plurality of compartments, each compartment used to store one ingredient for making cement;
a dispensing opening formed in a bottom area of each of the plurality of compartments;
a delivery trough positioned below each dispensing opening transferring the ingredient from each of the plurality of compartments to the cement mixing barrel; and
a metering device coupled to each dispensing opening, the metering device controlling disbursement of the ingredient in each of the plurality of compartments, wherein the metering device comprises:
a dispensing unit coupled to each dispensing opening; and
a controller coupled to each dispensing unit.

12. The system of claim 11, comprising a loading opening formed in a top area of each of the plurality of compartments.

13. The system of claim 11, comprising a container frame coupled to the container, wherein the container frame raises the container allowing the ingredient in each compartment to be dispensed out of the dispensing opening of each compartment.

14. The system of claim 13, wherein the container frame secures the container at an angle.

15. The system of claim 13, comprising wheels coupled to the container frame.

16. The system of claim 11, comprising a delivery trough frame coupled to the delivery trough, wherein the delivery trough frame positions the delivery trough below each of the dispensing openings and at a slant allowing each ingredient dispensed from each compartment to flow down the delivery trough.

17. The system of claim 11, wherein the metering device comprises a user interface coupled to the controller.

18. The system of claim 11, wherein a floor of each compartment is slanted.
